(19) United States
(12) Patent Application Publication
(10) Pub. No.: US 2008/0288542 A1
(43) Pub. Date: Nov. 20, 2008

(54) Media distribution kiosk

(76) Inventor: David B. Buttars, Park City, UT (US)

Correspondence Address: DAVID B. BUTTARS, 8774 GORGOZA DR, PARK CITY, UT, 84098, US

(21) Appl. No.: 12/150,227

(22) Filed: Apr. 25, 2008

Related U.S. Application Data
(60) Provisional application No. 60/914,280, filed on Apr. 26, 2007.
(60) Provisional application No. 60/914,282, filed on Apr. 26, 2007.
(60) Provisional application No. 60/914,283, filed on Apr. 26, 2007.
(60) Provisional application No. 60/914,286, filed on Apr. 26, 2007.

(51) Int. Cl. G06F 17/30

(52) U.S. Cl. 707/104.1; 707/E17.009

(57) ABSTRACT

This invention comprises a method and apparatus for the distribution of stored digital data files (Content). It's a kiosk device (Kiosk) which stores motion pictures, audio, video, multi-media, interactive media, etc. stored as Content for distribution to a Portable Data Storage Device (PDSD). This process loads a Drive Array(s) with Content creating a Content library, and associating the Drive Array(s) with a Kiosk(s). This makes the data immediately available for delivery to a PDSD without internet latency.

Millions of titles are available for delivery to their PDSD via linking multiple local Drive Arrays through a LAN connection to multiple Kiosks and their on-board Drive Arrays on the LAN.

Upon Content loading to the PDSD, the Kiosk generates a license object file containing the viewing parameters and permissions (License Object) associated with the Content file. The License Object is loaded to the PDSD along with the associated Content File.

### CROSS-REFERENCE TO RELATED U.S. PATENT DOCUMENTS

This is a Regular Nonprovisional Utility Patent Application under 35 U.S.C section 111(a). The entire disclosure of prior application Ser. No. 11/161,271 filed Jul. 28, 2005 and published Jan. 10, 2008, Publication no.: US 2008/008456 A1 is herein incorporated by reference.

Additionally, the entire disclosures of previously filed Provisional Utility Patent Application per 35 U.S.C. 111(b), Nos.: 60/914,280, 60/914,282, 60/914,283 and 60/914,286 inclusive.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

As used in this description and in the appended claims, the word ‘Content’ means; all digital data, including but not limited to motion pictures, audio, musical works, video, video games, multi-media, interactive media, data files, programs and other works stored as digital data files.

1. Field of the Invention

The invention relates to a method and apparatus for storage and distribution of audio, video, multi-media, interactive media, data files, programs and other works stored as digital data files.

2. Background

When a motion picture is released to the public it often follows a release schedule wherein it is release to the cinema market first, then after some period of time, it is released to optical disc (DVD, VCD, Blu-Ray, etc), and after another period of time it is released to cable television. Prior to release to optical disc, it is digitally encoded from it's original film or digital format to the format required for the intended optical disc. This digital file is then used to create a “master” optical disc, which is in-turn used to create optical discs for distribution. Both the production and distribution of these optical discs is relatively expensive, and so only motion pictures that are expected to create a significant return on the costs of production and distribution are released on optical disc. As a result, a vast quantity of motion pictures and other Content are never released to optical disc and they are left to languish in the archives of the Content owner, only generating occasional revenue through airings on broadcast or cable television.

In the past decade, strong movements to distribute motion pictures via the Internet have been made, but have not seen massive success due to core liabilities to Internet delivery. First and foremost Internet delivery is restricted due to overall capacity of the Internet infrastructure itself. The switching and routing capacity provided by the telecom providers is not capable of supporting wide-spread downloading of files the size of movies, particularly at higher definitions supported by DVD and Blu-Ray. As an example, Blockbuster Video rents on average approximately 40 million movies every Friday night. If these were suddenly converted to Internet downloads over that same 6-hour period, the data-load on the switching and routing infrastructure would literally bring the Internet to a grinding halt. This issue is not considered a permanent problem, but it will take many years to increase the capacity of the entire Internet infrastructure to accommodate these types of volumes. In addition to the infrastructure issues, Content security is a significant issue with Internet distribution models because the Content is generally downloaded to a Personal Computer (PC), and as a result, just like DVDs, the protection scheme is available for infinite scrutiny and analysis by dedicated hackers until they decipher the protection scheme. Also, due to inherent frailties in the dominant Operating System (OS), protection schemes that rely on any of the OS resources become subject to those same frailties. As a result of the risks associated with these issues, the Content selection available through the Internet is limited as Content owners choose to retain high-value Content to lower risk formats.

Cable Television services have offered both programmed and “on-demand” movie distribution, as well as a small amount of video game distribution for many years. Cable offers roughly the same quality levels as optical discs but must be viewed from a cable box specific to that provider. The “on-demand” selection of Content is quite restricted due to infrastructure costs, and the viewing experience is limited due to the inability of the cable system to provide for additional features that are readily available on optical disc, as optical discs can store a variety of digital files for access at any time. Security is another concern with Cable distribution. Cable does provide some level of security, simply due to the proprietary nature of the boxes, and the lack of readily available interfaces into these boxes. However, despite the relative security of these boxes, several illicit products are available to enable copying of content from Cable boxes from all manufacturers, and hence content owners tend to release to Cable at the same time as they release to DVD, and with the same understanding that piracy is inevitable once released to that format.

Despite the immense potential for digital formatting to improve the efficiency of motion picture distribution, the challenges of data-volume and security have kept it from fulfilling it's full potential.

### BRIEF SUMMARY OF THE INVENTION

The present invention comprises a method and apparatus for the distribution of audio, video, multi-media, interactive media, data files, programs and other works stored as digital data files. One embodiment of the invention relates to a freestanding, affixed, and/or integrated kiosk device (Kiosk Device) with an independent, on-board drive array or arrays, or a Local Area Network-connected drive array or arrays, or other large capacity data storage memory structures (Drive Array(s)), storing motion pictures, audio, video, multi-media, interactive media, data files, programs and other works stored as digital data files (Content) for distribution to a portable non-volatile memory storage device (Storage Device). The invention involves a manner of pre-loading a Drive Array(s) with any number of digital Content files creating a Content library, and then locally associating the Drive Array(s) with one or many Kiosk Devices. In this embodiment, locally associating these Drive Arrays, either on-board the Kiosk or via a LAN, makes the data immediately available to the user for delivery to their Storage Device without the latency incumbent to delivery across the Internet. In one embodiment, the Content library is updated via a connection to the Internet where updates are trickled into the Drive Array(s) over time, during low Internet usage periods. In this embodiment, a user would dock their Storage Device into the Kiosk Device using a Storage Device-specific multi-pin hardware interface and using a graphic user-interface (GUI), select from this Content library one or more titles, and delivery them to their Storage Device. In one embodiment, the user may search the Content files in the Content library using any number of meta-data associated with the Content files including but not limited to title, theme, studio, actors, directors, genre, date, and any other available meta-data. In one embodiment a user may have millions of titles available for delivery to their Storage Device via the linking of multiple local Drive Arrays through a LAN connection, either in a server room central to multiple Kiosk Devices on the LAN, or by linking multiple Kiosk Devices and their on-board Drive Arrays through a LAN. In this embodiment the user may have access to any number of movie trailers, advertisements for products and services, promotions, and a variety of other information intended for users of the Kiosk Devices. In one embodiment, when a user selects a Content file to be loaded to the Storage Device, the Kiosk Device generates a license object file containing the viewing parameters and permissions (License Object) associated with the Content file. The License Object is loaded to the Storage Device along with the associated Content File.

### BRIEF DESCRIPTION OF THE DRAWINGS

FIG. 1 is a block diagram of the Kiosk Device interface card

FIG. 2 is a block diagram of the Kiosk Device functional areas

FIG. 3 is a block diagram of the Kiosk Device communication elements

FIG. 4 is a block diagram of the Kiosk Device relationship with other system components.

FIG. 5 is a block diagram of the Kiosk Device within an example of entire system architecture.

### DETAILED DESCRIPTION OF THE INVENTION (preferred embodiment)

The present invention comprises a method and apparatus for the storage and distribution of motion pictures, audio, video, multi-media, interactive media, data files, programs and other works stored as digital data files (Content) for distribution to a portable non-volatile memory storage device (Storage Device). One embodiment of the invention relates to a set of hardware and software components in a freestanding, affixed, and/or integrated kiosk device (Kiosk Device) with an independent, on-board drive array or arrays, or a Local Area Network-connected drive array or arrays, or other large capacity data storage memory structures (Drive Array(s)), storing Content for distribution to a Storage Device.

In one embodiment, the Kiosk Device and Drive Array(s) are co-located in a freestanding device placed in a location convenient to a flow of targeted user traffic, such as a mall, convenience store, video rental store, retail store, or other applicable location. In this embodiment the Kiosk Device is connected to the Internet to receive updates to the Drive Array(s), the hardware and/or software, and to validate payment and user-account information. In another embodiment, any number of Kiosk Devices are located at some distance from the Drive Array(s) which are located in a server room or other facility and connected to the Kiosk Device via a LAN connection. In this embodiment, the Kiosk Device is connected to the Internet to receive updates to the hardware and/or software and to validate payment and user-account information, and the Drive Array(s) are connected to the Internet to receive Content updates.

For example, in a major retail establishment, a room in the back of the store may be dedicated to house a server and large number of Drive Arrays, which are loaded with several million Content files. At the front of the store, a bank of several dozen Kiosk Devices are arranged where customers may dock their Storage Device, search through the Content files, and select some quantity of these files for loading to their Storage Device. Alternatively, in a convenience store, an independent, freestanding Kiosk Device with on-board Drive Array(s) holding tens of thousands of Content files is placed at the front of the store, and customers dock their Storage Device, search through the Content files, and select some quantity of these files for loading to their Storage Device. In an installation in a shopping mall, several freestanding Kiosk Devices with on-board Drive Array(s) holding tens of thousands of Content files are placed throughout the mall, and linked together via a LAN wherein each Kiosk Device shares the Content resources of the others' Drive Array(s) giving the user access to the sum total of all Content files on all Drive Array(s) in the mall.

In one embodiment, an existing kiosk of different manufacture may be adapted to become a Kiosk Device of this invention by integrating the required hardware and software into the casement and interface of the existing kiosk. For example, an existing digital photo printing kiosk may be modified with all the hardware and software necessary to gain the functionality of a Kiosk Device of this invention. Thus, a user would dock their Storage Device in the compatible interface installed on the photo printing kiosk, and have access to all of the features of a Kiosk Device of this invention.

In one embodiment, the Drive Arrays are loaded with a Content library at the point of assembly, and shipped to the Kiosk Device assembly location where they are installed into the Kiosk Device. In another embodiment, the Drive Arrays are loaded with a Content library at the point of assembly, and are shipped to the installation location, where they are installed into a LAN and addressed to some number of Kiosk Devices. In another embodiment, the Drive Arrays are loaded with a Content library via a connection to the Internet either at the point of assembly or at the installation location.

In one embodiment, the Kiosk Device generates a license object file containing the viewing parameters and permissions (License Object) associated with a Content file selected for loading to the Storage Device. In this embodiment, the License Object may specify a variety of viewing parameters for the Content file, including, but not limited to number of viewing sessions, number of hours or days in which viewing may take place, a combination of time and sessions, or any other parameter which may be or may become advantageous.

In one embodiment, the user docks a Storage Device into a Kiosk Device, and the software of the Kiosk Device references the user's profile information stored on their Storage Device to determine correlations between that profile information and the Content stored on the Drive Arrays. For example, upon docking the Storage Device into the Kiosk Device, the user is shown a welcome screen from the GUI which identifies them by name, and details the status of the docked Storage Device, showing information including but not limited to the number of active Content files on the Storage Device, Content files with associated License Objects that are about to expire, partially viewed Content files, remaining capacity of the Storage Device, recently expired License Objects, and other information that is, or becomes advantageous to display. In this embodiment, the GUI may then show the user Content files that have strong correlation with the user profile, may suggest promotional data including, but not limited to, film trailers, advertisements, news programs, sports and music video files, and any other video, audio, multi-media, and other data based on its correlation with the user profile, and, when a Content file is selected by the user for loading to the Storage Device, may load movie trailers to run with that Content file based on their correlation with the user profile.

In an embodiment, the Kiosk Device may be loaded with geographically centric data including, but not limited to local restaurants, retail stores, fairs, convention centers, expos, amusement centers/parks, points of local interest, hotels, and other locally-specific data, and said data is loaded to the Storage Device based on correlation between the data and use patterns stored in the user profile assigned to the Storage Device. For example, a user who lives in Los Angeles may travel to Boston, and while there docks their Storage Device in a Kiosk Device at their hotel. The Kiosk Device recognizes from the user profile stored on the Storage Device that the user is from Los Angeles, and after reviewing the data in the user profile for correlations may suggest any of a number of promotions or advertisements as applicable.

In one embodiment, the Kiosk Device hardware and software may be embedded in a Playback Device, providing all of the Kiosk Device functions to the user at the Playback Device location. In this embodiment, the Drive Arrays are located at a regional data center and are accessed via the Internet through the Kiosk-enabled Playback Device. For example, a user docks their Storage Device into a Kiosk-enabled Playback Device in their living room. They select a Content file for viewing and view the motion picture. At the end of the motion picture, they are prompted to decide if they would like to extend the time period of the License Object, convert the License Object into a permanent purchase License Object, or see other Content files similar to the Content file just viewed. The user may browse the suggested Content files, and load additional Content files to the Storage Device from the suggested list, or from a new Content library search initiated through the Kiosk-enabled Playback Device.

In one embodiment, the user may find that the Content file they are searching for is not in the Content library associated with the Kiosk Device they are currently using. In this embodiment, the user may request that this Content file be updated to the Content library. In this embodiment the Kiosk Device requests the Content file from the head-end system, and if available, the Content file is streamed to the appropriate Content library via an Internet connection, and once loaded, a notification is sent to the user based on contact information in the user profile. The notification may be sent via email, SMS, IM, text, or any other modality that is, or may become enabled in the system.

In an embodiment, the user may use the Kiosk Device to gain access to their user account through the GUI on the Kiosk Device, and may log into their user account, manage the account parameters, user profile, user groups, and other elements of the user account as enabled by the specific Kiosk Device being used.

### DETAILED DESCRIPTION OF THE INVENTION (written description integrating the drawings)

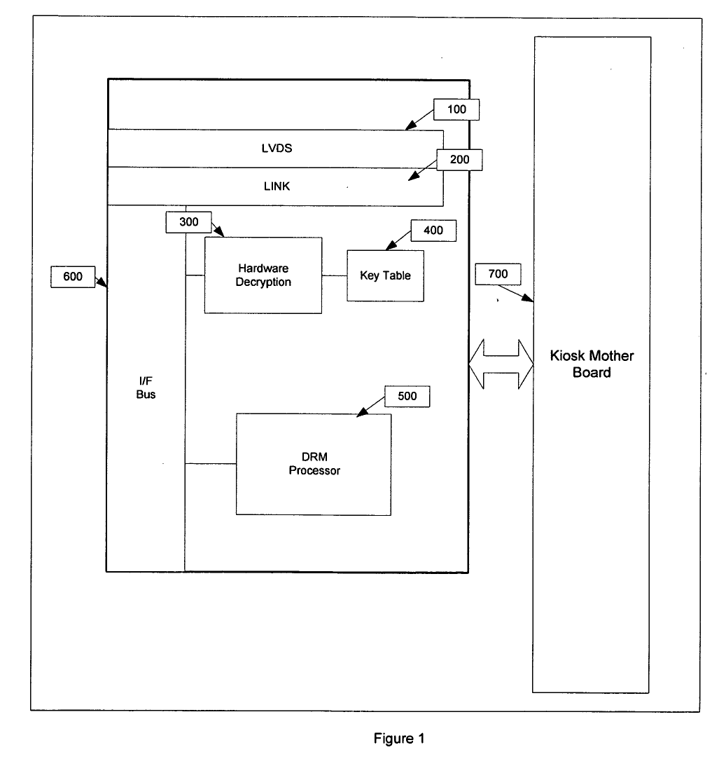

FIG. 1 shows the PCI interface card which provides the Kiosk Device computer the ability to communicate with the Storage Device in an embodiment of the system. The Storage Device docks with a multi-pin, board-to-board hardware interface and through a Low Voltage Differential Signaling (LVDS) interface (100). The Storage Device is authenticated across the PCI bus (600) by firmware driven by the on-board processor (500). Data is moved from the Kiosk Device to the on board non-volatile memory (700), and addressed with a file ID.

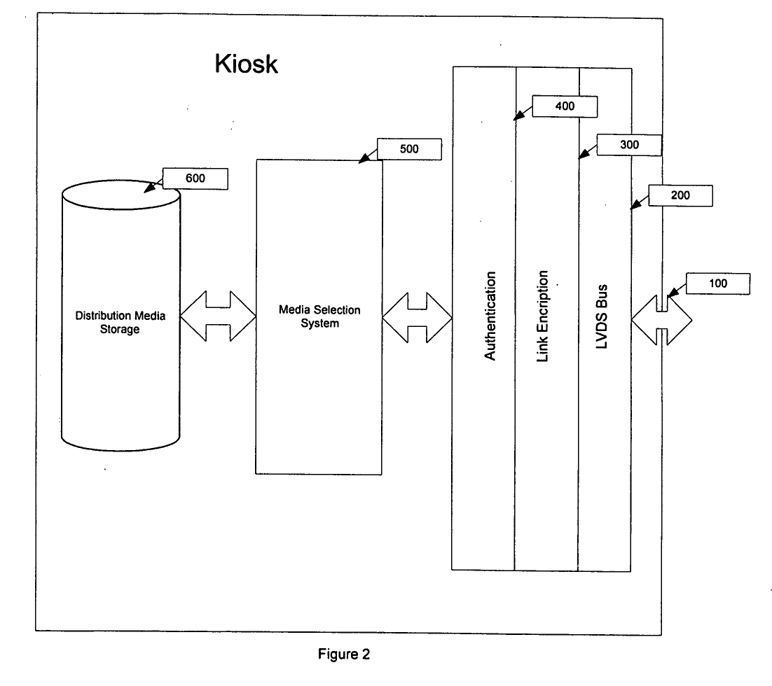

FIG. 2 shows the main functional areas of the Kiosk Device. The Storage Device docks with a multi-pin, board-to-board hardware interface (100), and through a Low Voltage Differential Signaling (LVDS) interface (200). Upon docking, the Storage Device is authenticated (400) to ensure it is an authorized device. Data moving from the Kiosk Device to the Storage Device, or from the Storage Device to the Kiosk Device is link encrypted (300). The Kiosk Device computer provides the GUI and processing for the selection of Content (500) from the Content library (600).

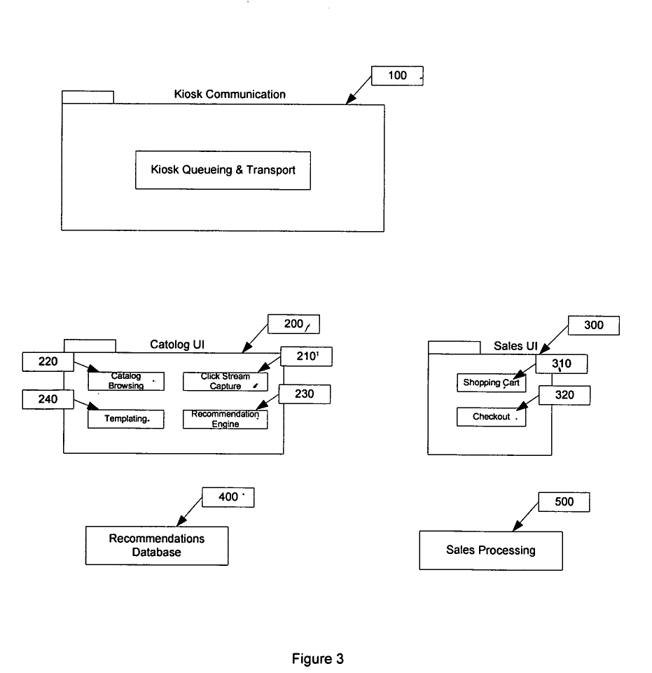

FIG. 3 shows the communication components for the Kiosk Device in an embodiment of the invention. All high-level Kiosk Device communication to the head-end, databases, and subroutine elements is managed by the Kiosk Communications (100). From the Catalog User Interface (200), a user initiates a browsing session via a search or by opening a segment of, or the entire library for browsing (220) and may initiate subroutines based on the actions made during the browsing session, to include moving (210) a Content file to the Shopping Cart (310), or creating a list (240) of Content files from which to choose from for loading to the Storage Device at a later time. Alternatively, the user may wish to allow the Recommendation Engine (230) to provide selections of Content from the Recommendations Database (400) that match the user profile contained on the Storage Device. The user may then open the Sales User Interface (300) to view files moved (210) to the Shopping Cart (310), and once ready to close the sale, checkout (320). Upon checkout, the Sales Processing engine (500) verifies and completes the transaction.

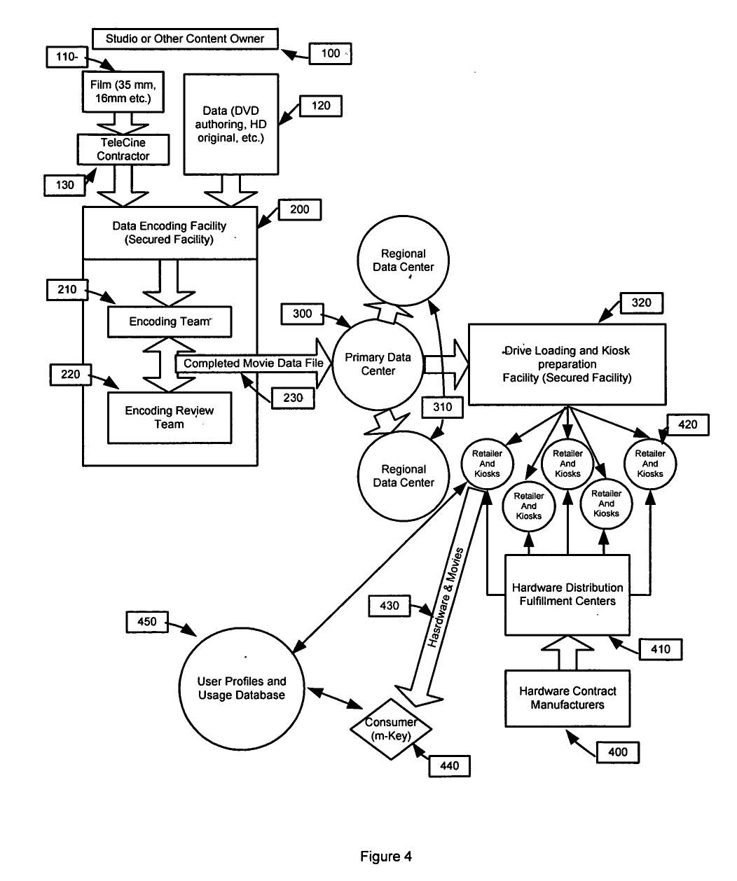

FIG. 4 shows the flow of data across an entire system containing an embodiment of the invention. Content is received from a Studio or Content Owner (100) in either Film (110), or digital format (120). If received in film, it is converted to digital format through a Tele Cine service (130). Once the Content is in digital form, it is delivered to a secured Data Encoding Facility (200) where an Encoding Team (210) applies encoding to the Content, the encoding process is verified by an Encoding Review Team (220) and once certified, the Completed Data File (230) is delivered to the Primary Data Center (300), and subsequently Kiosk Drives (320) or to Regional Data Centers (310). Storage Devices and Playback Devices are manufactured at CEM facilities (400) and distributed through a variety of distribution relationships (410), to retail facilities (420), and from there to the Consumer (440) through a variety of retail channels (430). Data regarding customer use patterns, as well as any attempts at hacking the system are aggregated and tracked using Usage Databases (450), and that data is pushed back to the Kiosks (420) should a Storage Device show hacking patterns.

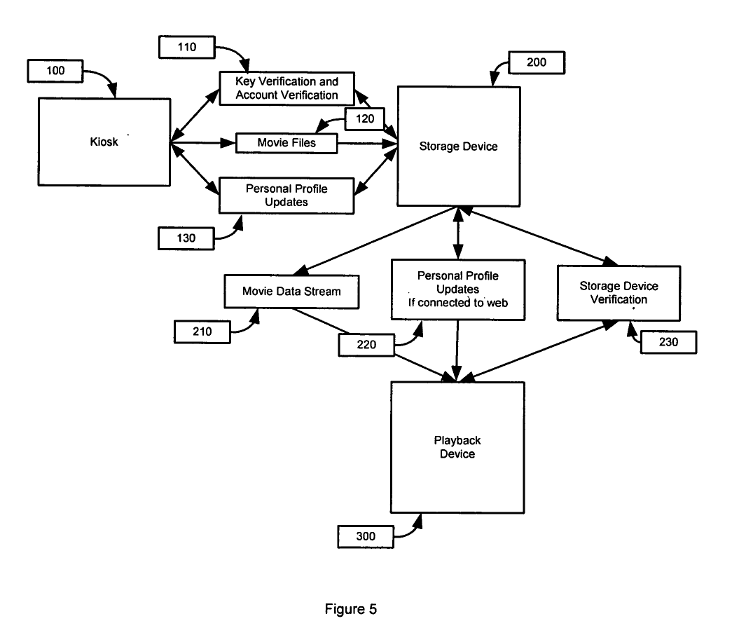

FIG. 5 shows the relationships of the core components of a system containing and embodiment of the invention. From the Content distribution Kiosk (100), Content files (120) are moved to Storage Devices (200) only after verification of the devices, encryption keys, and user accounts (110), and any updates to Personal Profiles (130) affecting security settings are affected. When the Storage Device (200) is docked into a Playback Device (300), the Storage Device is verified (230), and the Content Data is streamed (210) to the Playback Device (300). If the Playback Device (300) is connected to the web, then the Storage Device verification (230) will include a security update to confirm the validity of the Storage Device, as well as Personal Profile Updates (220).

What is claimed is:

1. An apparatus for the distribution of motion pictures, audio, video, multi-media, interactive media, data files, programs and other works stored as digital data files (Content) to portable, non-volatile memory storage devices (Storage Device) comprising:
(a) a freestanding, affixed, and/or integrated kiosk device (Kiosk Device) with a hardware interface for use with compatible Storage Devices; and
(b) A connected, large capacity data storage memory structure or structures (Drive Array(s)), storing motion pictures, audio, video, video games, multi-media, interactive media, data files, programs and/or other works stored as digital data files (Content as defined below) such that the integral combination of the kiosk device, GUI, license object system, and large capacity data storage memory structure(s) acts as an apparatus for distributing Content.

2. A method for the distribution of motion pictures, audio, video, video games, multi-media, interactive media, data files, programs and other works stored as digital data files (Content) to portable, non-volatile memory storage devices (Storage Device) comprising:
(a) A Graphic User Interface (GUI) to a freestanding, affixed, and/or integrated kiosk device (Kiosk Device) with a hardware interface for use with compatible Storage Devices, for users to search, select, and load Content to their Storage Device.
(b) A system for generating a license object file containing the viewing parameters and permissions (License Object) associated with the Content file.
(c) A connected, large capacity data storage memory structure or structures (Drive Array(s)), storing motion pictures, audio, video, multi-media, interactive media, data files, programs and other works stored as digital data files (Content) such that the integral combination of the kiosk device, GUI, license object system, and large capacity data storage memory structure(s) acts as a method for distributing Content.

3. The apparatus of claim 1 or 2, or a combination thereof, integrating a Central Processing Unit (CPU) as a component of the Kiosk Device.

4. The method of claim 1 or 2 or a combination thereof, integrating the functionalities of the Kiosk Device described herein into a kiosk device of different manufacture and purpose, thus adding the functionalities of the method and apparatus described herein to that kiosk device of different manufacture.

5. The apparatus of claim 1 or 2 or a combination thereof, integrating the computer hardware and peripherals of the Kiosk Device described herein into a kiosk device of different manufacture and purpose, thus adding the hardware of the apparatus described herein to kiosk device of different manufacture.

6. The apparatus of claim 1 integrating into the CPU of the Kiosk Device a multi-component module (MCM) daughter-card and associated secure hardware interface providing a secure connection to a compatible Storage Device.

7. The apparatus of claim 5 manufacturing the MCM daughter-card as an Application Specific Integrated Circuit (ASIC) and /or other compatible technology.

8. The apparatus of claim 1 or 2 or a combination thereof, wherein the Drive Arrays are comprised of a plurality of computer hard-drives.

9. The apparatus of claim 1 or 2 or a combination thereof, comprising Drive Arrays of a plurality of non-volatile, solid-state memory media.

10. The method of claim 1 or 2 or a combination thereof, storing Content on the Drive Arrays at the head-end of the system, and shipping the Content to the Kiosk Device location.

11. The method of claim 1 or 2 or a combination thereof, loading Content to the Drive Arrays via an internet connection.

12. The method of claim 1 or 2 or a combination thereof, storing the Content on the Drive Arrays and arranging it in a searchable database compatible with the Storage Device (Content Library) such that a user may sort the Content files by any amount of meta-data that is available or that may become available in the future.

13. The method of claim 1 or 2 or a combination thereof, wherein the Kiosk Device identifies the user of the Storage Device by a user profile file maintained on the Storage Device.

14. The method of claim 10 wherein the Kiosk Device suggests Content to the user of the Storage Device based on logic that identifies correlation between the data and use patterns stored in the user profile assigned to the Storage Device and available Content in the Content Library.

15. The method of claim 10 wherein the Kiosk Device contains geographically centric data including, but not limited to local restaurants, retail stores, fairs, convention centers, expos, amusement centers/parks, points of local interest, hotels, and other locally-specific data, and said data is loaded to the Storage Device based on correlation between the data and use patterns stored in the user profile assigned to the Storage Device.

16. The method of claim 10 wherein the Content Library may be dynamically updated via the Internet with a Content file not currently stored on the Drive Array(s) prompted by a request from a user for a specific Content file.

17. The apparatus of claim 1 or 2 or a combination thereof, wherein the hardware of the Kiosk Device is contained within a Storage Device-compatible playback device (Playback Device).

18. The method of claim 1 or 2 or a combination thereof, wherein the Kiosk Device functionality is contained within a Playback Device.

19. The method of claim 1 or 2 or a combination thereof, wherein the GUI provides access to the user account of a Storage Device owner at the head-end of the system via an Internet connection.

20. The method of claim 1 or 2 or a combination thereof, wherein the Kiosk Device generates a license object file containing the viewing parameters and permissions (License Object) associated with a Content file selected for loading to the Storage Device.
